(19) United States
(12) Patent Application Publication
(10) Pub. No.: US 2024/0320792 A1
(43) Pub. Date: Sep. 26, 2024

(54) GENERATING A COMPOSITE IMAGE BASED ON REGIONS OF INTEREST

(71) Applicant: QUALCOMM Incorporated, San Diego, CA (US)

(72) Inventors: Jiafu LUO, Irvine, CA (US); Azam Sadiq Pasha KAPATRALA SYED, San Diego, CA (US); Rishi BHATTACHARYA, San Diego, CA (US); Chandan GERA, Hyderabad (IN); Mayank CHOPRA, Fremont, CA (US)

(21) Appl. No.: 18/186,805

(22) Filed: Mar. 20, 2023

(51) Int. Cl. G06T 5/50; G06F 3/01

(52) U.S. Cl. CPC G06T 5/50; G06F 3/013; G06T 2207/20221

(57) ABSTRACT

Systems and techniques are described herein for generating a composite image. For instance, a method for generating a composite image is provided. The method may include receiving first data representative of an image of a field of view from an array of photodiodes of an image sensor; receiving second data representative of an image of a region of interest within the field of view from a subset of the array of photodiodes, wherein the region of interest is smaller than the field of view, wherein the subset of the array of photodiodes within the array of photodiodes corresponds to the region of interest within the field of view, and wherein the subset of the array of photodiodes includes fewer photodiodes than the array of photodiodes; and generating a composite image of the field of view based on the first data and the second data.

### TECHNICAL FIELD

The present disclosure generally relates to generating a composite image. In some examples, aspects of the present disclosure are related to generating a composite image based one or more regions of interest.

### BACKGROUND

A camera is a device that receives light and captures image frames, such as still images or video frames, using an image sensor. Cameras may include one or more processors, such as image signal processors (ISPs), that can process one or more image frames captured by an image sensor. For example, a raw image frame captured by an image sensor can be processed by an image signal processor (ISP) to generate a final image. Cameras can be configured with a variety of image capture and image processing settings to alter the appearance of an image. Some camera settings are determined and applied before or while an image is captured, such as ISO, exposure time (also referred to as exposure duration and/or shutter speed), aperture size (also referred to as f/stop), focus, and gain, among others. Moreover, some camera settings can be configured for post-processing of an image, such as alterations to a contrast, brightness, saturation, sharpness, levels, curves, and colors, among others.

### SUMMARY

Systems and techniques are described for generating a composite image. According to at least one example, a method is provided for generating a composite image. The method includes: receiving first data representative of an image of a field of view from an array of photodiodes of an image sensor; receiving second data representative of an image of a region of interest within the field of view from a subset of the array of photodiodes, wherein the region of interest is smaller than the field of view, wherein the subset of the array of photodiodes within the array of photodiodes corresponds to the region of interest within the field of view, and wherein the subset of the array of photodiodes includes fewer photodiodes than the array of photodiodes; and generating a composite image of the field of view based on the first data and the second data.

In another example, an apparatus for generating a composite image is provided that includes at least one memory and at least one processor (e.g., configured in circuitry) coupled to the at least one memory. The at least one processor configured to: receive first data representative of an image of a field of view from an array of photodiodes of an image sensor; receive second data representative of an image of a region of interest within the field of view from a subset of the array of photodiodes, wherein the region of interest is smaller than the field of view, wherein the subset of the array of photodiodes within the array of photodiodes corresponds to the region of interest within the field of view, and wherein the subset of the array of photodiodes includes fewer photodiodes than the array of photodiodes; and generate a composite image of the field of view based on the first data and the second data.

In another example, a non-transitory computer-readable medium is provided that has stored thereon instructions that, when executed by one or more processors, cause the one or more processors to: receive first data representative of an image of a field of view from an array of photodiodes of an image sensor; receive second data representative of an image of a region of interest within the field of view from a subset of the array of photodiodes, wherein the region of interest is smaller than the field of view, wherein the subset of the array of photodiodes within the array of photodiodes corresponds to the region of interest within the field of view, and wherein the subset of the array of photodiodes includes fewer photodiodes than the array of photodiodes; and generate a composite image of the field of view based on the first data and the second data.

In another example, an apparatus for generating a composite image is provided. The apparatus includes: means for receiving first data representative of an image of a field of view from an array of photodiodes of an image sensor; means for receiving second data representative of an image of a region of interest within the field of view from a subset of the array of photodiodes, wherein the region of interest is smaller than the field of view, wherein the subset of the array of photodiodes within the array of photodiodes corresponds to the region of interest within the field of view, and wherein the subset of the array of photodiodes includes fewer photodiodes than the array of photodiodes; and means for generating a composite image of the field of view based on the first data and the second data.

In some aspects, one or more of the apparatuses described herein is, is part of, and/or includes a mobile device (e.g., a mobile telephone and/or mobile handset and/or so-called “smartphone” or other mobile device), a camera, an extended reality (XR) device (e.g., a virtual reality (VR) device, an augmented reality (AR) device, or a mixed reality (MR) device), a head-mounted device (HMD) device, a camera (e.g., an internet protocol (IP) camera, a surveillance camera, etc.), a vehicle or a computing system of the vehicle, device, or component of a vehicle, a wearable device (e.g., a network-connected watch or other wearable device), a wireless communication device, a personal computer, a laptop computer, a server computer, another device, or a combination thereof. In some aspects, the apparatus includes a camera or multiple cameras for capturing one or more images. In some aspects, the apparatus further includes a display for displaying one or more images, notifications, and/or other displayable data. In some aspects, the apparatuses described above can include one or more sensors (e.g., one or more inertial measurement units (IMUs), such as one or more gyroscopes, one or more gyrometers, one or more accelerometers, any combination thereof, and/or other sensors).

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

Illustrative aspects of the present application are described in detail below with reference to the following figures:

FIG. 1 is a block diagram illustrating an example architecture of an image-processing system 100, according to various aspects of the present disclosure;

FIG. 2 illustrates multiple images, captured with different image-capture parameters, and used to create an high-dynamic resolution (HDR) image;

FIG. 3 illustrates multiple images used to create a composite image, according to various aspects of the present disclosure;

FIG. 4 is a block diagram illustrating an environment including an image-processing system configured to generate an image representing a field of view, according to various aspects of the present disclosure;

FIG. 5 illustrates an example of a process for generating a composite image, according to aspects of the according to various aspects of the present disclosure; and

FIG. 6 illustrates an example computing-device architecture of an example computing device which can implement the various techniques described herein.

### DETAILED DESCRIPTION

Certain aspects of this disclosure are provided below. Some of these aspects may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and descriptions are not intended to be restrictive.

The ensuing description provides example aspects only and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the spirit and scope of the application as set forth in the appended claims.

The terms “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage, or mode of operation.

Electronic devices (e.g., mobile phones, wearable devices (e.g., smart watches, smart glasses, etc.), tablet computers, extended reality (XR) devices (e.g., virtual reality (VR) devices, augmented reality (AR) devices, mixed reality (MR) devices, and the like), connected devices, laptop computers, etc.) are increasingly equipped with camera hardware to capture image frames, such as still images and/or video frames, for consumption. For example, an electronic device can include a camera to allow the electronic device to capture a video or image of a scene, a person, an object, etc. Additionally, cameras themselves are used in a number of configurations (e.g., handheld digital cameras, digital single-lens-reflex (DSLR) cameras, worn camera (including body-mounted cameras and head-borne cameras), stationary cameras (e.g., for security and/or monitoring), vehicle-mounted cameras, etc.).

A camera is a device that receives light and captures image frames (e.g., still images or video frames) using an image sensor. In some examples, a camera may include one or more processors, such as image signal processors (ISPs), that can process one or more image frames captured by an image sensor. For example, a raw image frame captured by an image sensor can be processed by an image signal processor (ISP) of a camera to generate a final image. In some cases, an electronic device implementing a camera can further process a captured image or video for certain effects (e.g., compression, image enhancement, image restoration, scaling, framerate conversion, etc.) and/or certain applications such as computer vision, extended reality (e.g., augmented reality, virtual reality, and the like), object detection, image recognition (e.g., face recognition, object recognition, scene recognition, etc.), feature extraction, authentication, and automation, among others.

Moreover, cameras can be configured with a variety of image capture and image processing settings to alter the appearance of an image. Some camera settings can be determined and applied before or while an image is captured, such as ISO, exposure time (also referred to as exposure duration and/or shutter speed), aperture size (also referred to as f/stop), focus, and gain, among others. Some camera settings can be configured for post-processing of an image, such as alterations to a contrast, brightness, saturation, sharpness, levels, curves, and colors, among others. In some examples, a camera can be configured with certain settings to adjust the exposure of an image captured by the camera.

In photography, the exposure of an image captured by a camera refers to the amount of light per unit area that reaches a photographic film, or in modern cameras, an electronic image sensor (e.g., including an array of photodiodes). The exposure is based on certain camera settings such as, for example, exposure time, and/or lens aperture, as well as the luminance of the scene being photographed. Many cameras are equipped with an automatic exposure or “auto exposure” mode, where the exposure settings (e.g., exposure time, lens aperture, etc.) of the camera may be automatically adjusted to match, as closely as possible, the luminance of a scene or subject being photographed. In some cases, an automatic exposure control (AEC) engine can perform AEC to determine exposure settings for an image sensor.

In photography and videography, a technique called high dynamic range (HDR) allows the dynamic range of image frames captured by a camera to be increased beyond the native capability of the camera. In this context, a dynamic range refers to the range of luminosity between the brightest area and the darkest area of the scene or image frame. For example, a high dynamic range means there is large variation in light levels within a scene or an image frame. HDR can involve capturing multiple image frames of a scene with different exposures and combining captured image frames with the different exposures into a single image frame. The combination of image frames with different exposures can result in an image with a dynamic range higher than that of each individual image frame captured and combined to form the HDR image frame. For example, the electronic device can create a high dynamic range scene by combining two or more exposure frames into a single frame. HDR is a feature often used by electronic devices, such as smartphones and mobile devices, for various purposes. For example, in some cases, a smartphone can use HDR to achieve a better image quality or an image quality similar to the image quality achieved by a digital single-lens reflex (DSLR) camera.

In the present disclosure, the term “combine,” and like terms, with reference to images or image data, may refer to any suitable techniques for using information (e.g., pixels) from two or more images to generate an image (e.g., a “composite” image). For example, pixels from a first image and pixels from a second image may be combined to generate a composite image. In such cases some of the pixels of the composite image may be from the first image and others of the pixels of the composite image may be from the second image. In some cases, some of the pixels from the first image and the second image may be merged, fused, or blended. For example, color and/or intensity values for pixels of the composite image may be based on respective pixels from both the first image and the second image. For instance, a given pixel of the composite image may be based on an average, or a weighted average, between a corresponding pixel of the first image and a corresponding pixel of the second image (e.g., the corresponding pixels of the first image and the second image may be blended). As one example, a central region of a first image may be included in a composite image. Further, an outer region of a second of a second image may be included in the composite image. Pixels surrounding the central region in the composite image may be based on weighted averages between corresponding pixels of the first image and corresponding pixels of the second image. In other words, pixels of the first image surrounding the central region may be merged, fused, or blended with pixels of the second image inside the outer region.

In some cases, an imaging device can generate an HDR image by combining multiple images that captured with different exposure settings. For instance, an imaging device can generate an HDR image by combining a short-exposure image captured with a short exposure time and a long-exposure image captured with a long exposure time that is longer than the short exposure time. As another example, the imaging device can create an HDR image using a short-exposure image, a medium exposure image (that is capture with a medium exposure time that is between the short exposure time and the long exposure time), and a long-exposure image.

Because short-exposure images are generally dark, they generally preserve the most detail in the highlights (bright areas) of a photographed scene. Medium-exposure images and the long-exposure images are generally brighter than short-exposure images, and may be overexposed (e.g., too bright to make out details) in the highlight portions (bright areas) of the scene. Because long-exposure images generally include bright portions, they may preserve detail in the shadows (dark areas) of a photographed scene. Medium-exposure images and the short-exposure images are generally darker than long-exposure images, and may be underexposed (e.g., too dark to make out details in) in the shadow portions (dark areas) of the scene, making their depictions of the shadows too dark to observe details. To generate an HDR image, the imaging device may, for example, use portions of the short-exposure image to depict highlights (bright areas) of the photographed scene, use portions of the long-exposure image depicting shadows (dark areas) of the scene, and use portions of the medium-exposure image depicting other areas (other than highlights and shadows) of a scene.

In some cases, an image-processing system (e.g., included in a camera or device including a camera) can provide image frames from an image-capture device to an image-processing device (e.g., by causing the image-capture device to write the image frames to a memory), such as a double data rate (DDR) synchronous dynamic random-access memory (SDRAM) or any other memory device. The image-processing device can retrieve the image frames from the memory and combine the image frames into a single image. However, the write and read operations used to create the HDR image can result in significant power, bandwidth, and/or time consumption.

For example, generating two images (e.g., two full-readout images) of a scene can increase (e.g., double) a required data throughput (e.g., between the image-capture device and the image-processing device), as compared with imaging devices that do not implement HDR techniques. In the present disclosure, the term “full-readout image” may refer to an image including data sensed at each photodiode of an array of photodiodes of an image sensor (where all photodiodes of the image sensor are used for the full-readout image). Such an increase in required data throughput can increase latency and power consumption of a device in generating HDR images. Further, an image-processing device processing two full-readout images of a scene, instead of a single image of the scene, can increase data processing, memory requirements, and/or power consumption of the camera. Such an increase in data processing, memory requirements, and/or power consumption can impact battery life of devices.

The present disclosure describes systems, apparatuses, methods (also referred to herein as processes), and computer-readable media (collectively referred to as “systems and techniques”) for generating composite images. For example, aspects of the disclosure include generating a composite image (e.g., an HDR image) by combining image data (e.g., pixels) from at least one image (e.g., a full-readout image) with image data from at least one other image (e.g., a partial-readout image). In the present disclosure, the term “partial-readout image” may refer to an image including data sensed at a subset of the photodiodes (less than all photodiodes) of an array of photodiodes of an image sensor. For example, a partial-readout image may be an image as captured by a quadrant of photodiodes of an array of photodiodes of an image sensor.

As an example, an image-capture device of a device may capture a first image (e.g., a full-readout image) of a field of view and generate data representative of the image. In the present disclosure, the term “field of view” may refer to a maximum area of a scene that an image sensor of an image-capture device can capture according to the parameters (e.g., including focal length, aperture size, size of the image sensor in terms of number of photodiodes and sizes of the photodiodes, etc.) of the image-capture device. For example, a full-readout image may include an image of a full field of view. The image-capture device may provide the data representative of the first image to an image-processing device of the device (e.g., by writing the data to a memory of the image-processing device).

Continuing with the above example, the image-processing device may obtain (e.g., by determining or by being provided with an indication of) a region of interest within the field of view of the image sensor. In some instances, the region of interest may be identified based on the first image (e.g., the full-readout image). In other instances, the region of interest may be identified based on one or more other images (e.g., a preview image). Additionally, or alternatively, the region of interest may be identified based on other data (e.g., based on a gaze of a viewer).

The image-capture device and/or the image-processing device may determine or identify a subset of the photodiodes of an array of photodiodes of the image sensor corresponding to the region of interest. In some cases, the image-capture device and/or the image-processing device may identify the subset of photodiodes of the image sensor based on a correspondence between a location of the region of interest within the field of view and a location of the subset of photodiodes within the array of photodiodes. In one illustrative example, if the region of interest includes a rectangular region in a quadrant of the field of view, the subset of photodiodes may include a rectangle-shaped group of photodiodes in a corresponding quadrant of the array of photodiodes.

Once the subset of photodiodes is identified, the image-capture device may capture a second image (e.g., a partial-readout image) using the identified subset of photodiodes. The image-capture device may provide data representative of the second image to the image-processing device. The image-processing device can then generate composite image (e.g., an HDR image) using the full-readout image and the partial-readout image.

The partial-readout images used by the systems and techniques described herein include less data than data representative of full-readout images used by conventional HDR techniques that use multiple full-readout images for generating a composite image. Because the data of the partial-readout images is smaller than the full read-out images of conventional HDR techniques, the required data throughput of systems and techniques described herein is less than the required data throughput of conventional HDR techniques. Similarly, the data processing and memory requirements of systems and techniques described herein is less than that of conventional HDR techniques.

The systems and techniques described herein can mitigate the disadvantages of using multiple full-readout images for generating a composite image. For example, the systems and techniques described herein may decrease latency, power consumption, data processing requirements, memory requirements, etc., while still providing the advantages of using multiple images to increase the dynamic range of a composite image.

Additionally, although many of the examples of the present disclosure relate to HDR, the present disclosure is not limited to HDR. For example, the systems and techniques described herein may be applied to other computational photography techniques, such as multi-frame noise reduction (MFNR), super-resolution techniques, and/or other techniques. For example, MFNR and/or super-resolution techniques can be applied to a particular region of interest to reduce noise (in the case of MFNR) and/or to increase resolution (in the case of super-resolution) in the region. According to the systems and techniques described herein, the particular region can be a partial-readout image from an image sensor.

Various aspects of the systems and techniques are described herein and will be discussed below with respect to the figures.

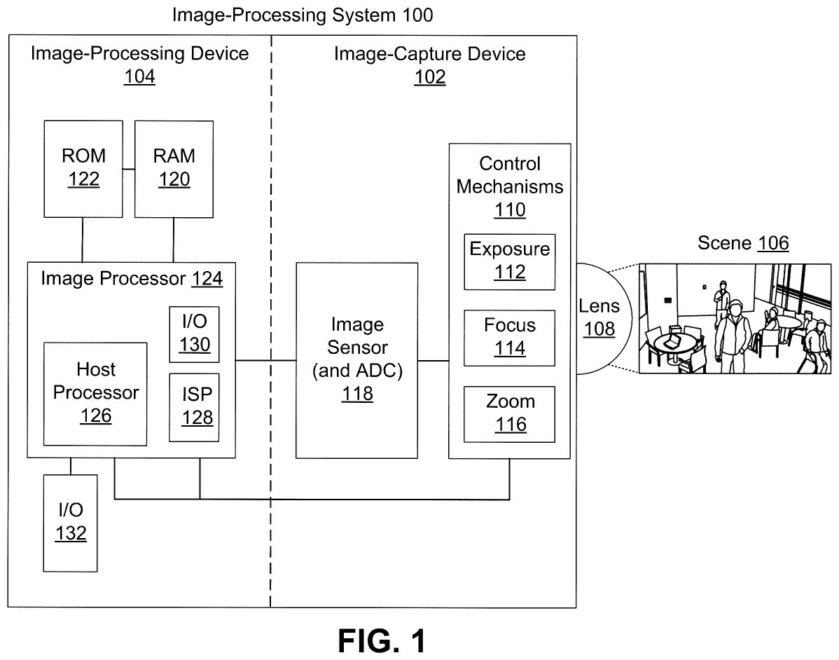

FIG. 1 is a block diagram illustrating an example architecture of an image-processing system 100, according to various aspects of the present disclosure. The image-processing system 100 includes various components that are used to capture and process images, such as an image of a scene 106. The image-processing system 100 can capture image frames (e.g., still images or video frames). In some cases, the lens 108 and image sensor 118 (which may include an analog-to-digital converter (ADC)) can be associated with an optical axis. In one illustrative example, the photosensitive area of the image sensor 118 (e.g., the photodiodes) and the lens 108 can both be centered on the optical axis.

In some examples, the lens 108 of the image-processing system 100 faces a scene 106 and receives light from the scene 106. The lens 108 bends incoming light from the scene toward the image sensor 118. The light received by the lens 108 then passes through an aperture of the image-processing system 100. In some cases, the aperture (e.g., the aperture size) is controlled by one or more control mechanisms 110. In other cases, the aperture can have a fixed size.

The one or more control mechanisms 110 can control exposure, focus, and/or zoom based on information from the image sensor 118 and/or information from the image processor 124. In some cases, the one or more control mechanisms 110 can include multiple mechanisms and components. For example, the control mechanisms 110 can include one or more exposure-control mechanisms 112, one or more focus-control mechanisms 114, and/or one or more zoom-control mechanisms 116. The one or more control mechanisms 110 may also include additional control mechanisms besides those illustrated in FIG. 1. For example, in some cases, the one or more control mechanisms 110 can include control mechanisms for controlling analog gain, flash, HDR, depth of field, and/or other image capture properties.

The focus-control mechanism 114 of the control mechanisms 110 can obtain a focus setting. In some examples, focus-control mechanism 114 stores the focus setting in a memory register. Based on the focus setting, the focus-control mechanism 114 can adjust the position of the lens 108 relative to the position of the image sensor 118. For example, based on the focus setting, the focus-control mechanism 114 can move the lens 108 closer to the image sensor 118 or farther from the image sensor 118 by actuating a motor or servo (or other lens mechanism), thereby adjusting the focus. In some cases, additional lenses may be included in the image-processing system 100. For example, the image-processing system 100 can include one or more microlenses over each photodiode of the image sensor 118. The microlenses can each bend the light received from the lens 108 toward the corresponding photodiode before the light reaches the photodiode.

In some examples, the focus setting may be determined via contrast detection autofocus (CDAF), phase detection autofocus (PDAF), hybrid autofocus (HAF), or some combination thereof. The focus setting may be determined using the control mechanism 110, the image sensor 118, and/or the image processor 124. The focus setting may be referred to as an image capture setting and/or an image processing setting. In some cases, the lens 108 can be fixed relative to the image sensor and the focus-control mechanism 114.

The exposure-control mechanism 112 of the control mechanisms 110 can obtain an exposure setting. In some cases, the exposure-control mechanism 112 stores the exposure setting in a memory register. Based on the exposure setting, the exposure-control mechanism 112 can control a size of the aperture (e.g., aperture size or f/stop), a duration of time for which the aperture is open (e.g., exposure time or shutter speed), a duration of time for which the sensor collects light (e.g., exposure time or electronic shutter speed), a sensitivity of the image sensor 118 (e.g., ISO speed or film speed), analog gain applied by the image sensor 118, or any combination thereof. The exposure setting may be referred to as an image capture setting and/or an image processing setting.

The zoom-control mechanism 116 of the control mechanisms 110 can obtain a zoom setting. In some examples, the zoom-control mechanism 116 stores the zoom setting in a memory register. Based on the zoom setting, the zoom-control mechanism 116 can control a focal length of an assembly of lens elements (lens assembly) that includes the lens 108 and one or more additional lenses. For example, the zoom-control mechanism 116 can control the focal length of the lens assembly by actuating one or more motors or servos (or other lens mechanism) to move one or more of the lenses relative to one another. The zoom setting may be referred to as an image capture setting and/or an image processing setting. In some examples, the lens assembly may include a parfocal zoom lens or a varifocal zoom lens. In some examples, the lens assembly may include a focusing lens (which can be lens 108 in some cases) that receives the light from the scene 106 first, with the light then passing through an afocal zoom system between the focusing lens (e.g., lens 108) and the image sensor 118 before the light reaches the image sensor 118. The afocal zoom system may, in some cases, include two positive (e.g., converging, convex) lenses of equal or similar focal length (e.g., within a threshold difference of one another) with a negative (e.g., diverging, concave) lens between them. In some cases, the zoom-control mechanism 116 moves one or more of the lenses in the afocal zoom system, such as the negative lens and one or both of the positive lenses. In some cases, zoom-control mechanism 116 can control the zoom by capturing an image from an image sensor of a plurality of image sensors (e.g., including image sensor 118) with a zoom corresponding to the zoom setting. For example, the image-processing system 100 can include a wide-angle image sensor with a relatively low zoom and a telephoto image sensor with a greater zoom. In some cases, based on the selected zoom setting, the zoom-control mechanism 116 can capture images from a corresponding sensor.

The image sensor 118 includes one or more arrays of photodiodes or other photosensitive elements. Each photodiode measures an amount of light that eventually corresponds to a particular pixel in the image produced by the image sensor 118. In some cases, different photodiodes may be covered by different filters. In some cases, different photodiodes can be covered in color filters, and may thus measure light matching the color of the filter covering the photodiode. Various color filter arrays can be used such as, for example and without limitation, a Bayer color filter array, a quad color filter array (QCFA), and/or any other color filter array.

In some cases, the image sensor 118 may alternately or additionally include opaque and/or reflective masks that block light from reaching certain photodiodes, or portions of certain photodiodes, at certain times and/or from certain angles. In some cases, opaque and/or reflective masks may be used for phase detection autofocus (PDAF). In some cases, the opaque and/or reflective masks may be used to block portions of the electromagnetic spectrum from reaching the photodiodes of the image sensor (e.g., an IR cut filter, a UV cut filter, a band-pass filter, low-pass filter, high-pass filter, or the like). The image sensor 118 may also include an analog gain amplifier to amplify the analog signals output by the photodiodes and/or an analog to digital converter (ADC) to convert the analog signals output of the photodiodes (and/or amplified by the analog gain amplifier) into digital signals. In some cases, certain components or functions discussed with respect to one or more of the control mechanisms 110 may be included instead or additionally in the image sensor 118. The image sensor 118 may be a charge-coupled device (CCD) sensor, an electron-multiplying CCD (EMCCD) sensor, an active-pixel sensor (APS), a complimentary metal-oxide semiconductor (CMOS), an N-type metal-oxide semiconductor (NMOS), a hybrid CCD/CMOS sensor (e.g., sCMOS), or some other combination thereof.

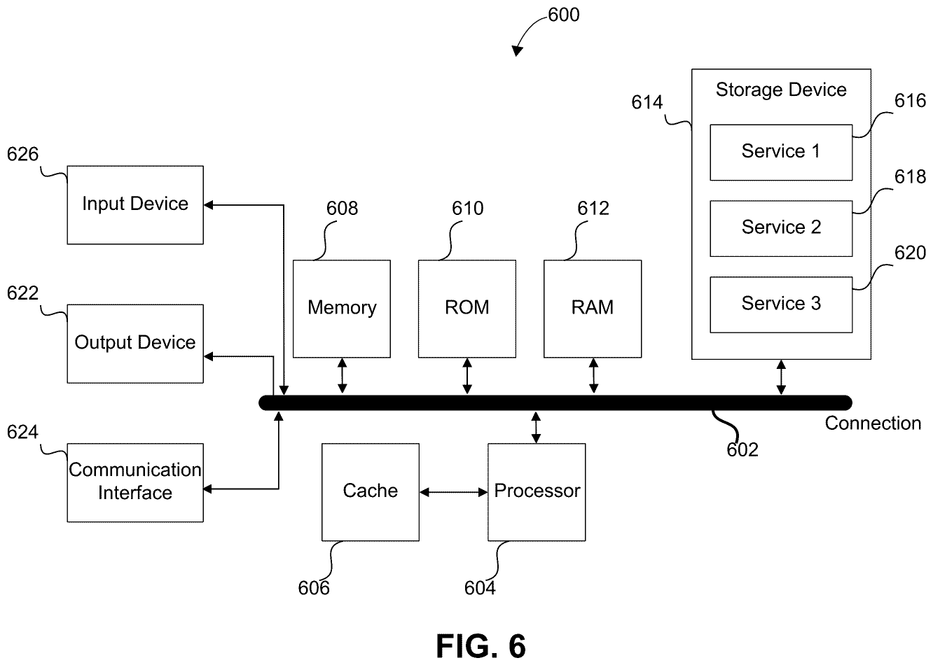

The image processor 124 may include one or more processors, such as one or more image signal processors (ISPs) (including ISP 128), one or more host processors (including host processor 126), and/or one or more of any other type of processor discussed with respect to the computing-device architecture 600 of FIG. 6. The host processor 126 can be a digital signal processor (DSP) and/or other type of processor. In some implementations, the image processor 124 is a single integrated circuit or chip (e.g., referred to as a system-on-chip or SoC) that includes the host processor 126 and the ISP 128. In some cases, the chip can also include one or more input/output ports (e.g., input/output (I/O) ports 130), central processing units (CPUs), graphics processing units (GPUs), broadband modems (e.g., 3G, 4G or LTE, 5G, etc.), memory, connectivity components (e.g., Bluetooth™, Global Positioning System (GPS), etc.), any combination thereof, and/or other components. The I/O ports 130 can include any suitable input/output ports or interface according to one or more protocol or specification, such as an Inter-Integrated Circuit 2 (I2C) interface, an Inter-Integrated Circuit 3 (I3C) interface, a Serial Peripheral Interface (SPI) interface, a serial General Purpose Input/Output (GPIO) interface, a Mobile Industry Processor Interface (MIPI) (such as a MIPI CSI-2 physical (PHY) layer port or interface, an Advanced High-performance Bus (AHB) bus, any combination thereof, and/or other input/output port. In one illustrative example, the host processor 126 can communicate with the image sensor 118 using an I2C port, and the ISP 128 can communicate with the image sensor 118 using an MIPI port.

The image processor 124 may perform a number of tasks, such as de-mosaicing, color space conversion, image frame downsampling, pixel interpolation, automatic exposure (AE) control, automatic gain control (AGC), CDAF, PDAF, automatic white balance, combining of image frames to form a composite image (e.g., an HDR image), image recognition, object recognition, feature recognition, receipt of inputs, managing outputs, managing memory, or some combination thereof. The image processor 124 may store image frames and/or processed images in random-access memory (RAM) 120, read-only memory (ROM) 122, a cache, a memory unit, another storage device, or some combination thereof.

Various input/output (I/O) devices 132 may be connected to the image processor 124. The I/O devices 132 can include a display screen, a keyboard, a keypad, a touchscreen, a trackpad, a touch-sensitive surface, a printer, any other output devices, any other input devices, or any combination thereof. In some cases, a caption may be input into the image-processing device 104 through a physical keyboard or keypad of the I/O devices 132, or through a virtual keyboard or keypad of a touchscreen of the I/O devices 132. The I/O devices 132 may include one or more ports, jacks, or other connectors that enable a wired connection between the image-processing system 100 and one or more peripheral devices, over which the image-processing system 100 may receive data from the one or more peripheral device and/or transmit data to the one or more peripheral devices. The I/O devices 132 may include one or more wireless transceivers that enable a wireless connection between the image-processing system 100 and one or more peripheral devices, over which the image-processing system 100 may receive data from the one or more peripheral device and/or transmit data to the one or more peripheral devices. The peripheral devices may include any of the previously-discussed types of the I/O devices 132 and may themselves be considered I/O devices 132 once they are coupled to the ports, jacks, wireless transceivers, or other wired and/or wireless connectors.

In some cases, the image-processing system 100 may be a single device. In some cases, the image-processing system 100 may be two or more separate devices, including an image-capture device 102 (e.g., a camera) and an image-processing device 104 (e.g., a computing device coupled to the camera). In some implementations, the image-capture device 102 and the image-capture device 102 may be coupled together, for example via one or more wires, cables, or other electrical connectors, and/or wirelessly via one or more wireless transceivers. In some implementations, the image-capture device 102 and the image-processing device 104 may be disconnected from one another.

As shown in FIG. 1, a vertical dashed line divides the image-processing system 100 of FIG. 1 into two portions that represent the image-capture device 102 and the image-processing device 104, respectively. The image-capture device 102 includes the lens 108, control mechanisms 110, and the image sensor 118. The image-processing device 104 includes the image processor 124 (including the ISP 128 and the host processor 126), the RAM 120, the ROM 122, and the I/O device 132. In some cases, certain components illustrated in the image-capture device 102, such as the ISP 128 and/or the host processor 126, may be included in the image-capture device 102. In some examples, the image-processing system 100 can include one or more wireless transceivers for wireless communications, such as cellular network communications, 802.11 wi-fi communications, wireless local area network (WLAN) communications, or some combination thereof.

The image-processing system 100 can be part of, or implemented by, a single computing device or multiple computing devices. In some examples, the image-processing system 100 can be part of an electronic device (or devices) such as a camera system (e.g., a digital camera, an IP camera, a video camera, a security camera, etc.), a telephone system (e.g., a smartphone, a cellular telephone, a conferencing system, etc.), a laptop or notebook computer, a tablet computer, a set-top box, a smart television, a display device, a game console, an XR device (e.g., an HMD, smart glasses, etc.), an IoT (Internet-of-Things) device, a smart wearable device, a video streaming device, an Internet Protocol (IP) camera, or any other suitable electronic device(s).

The image-capture device 102 and the image-processing device 104 can be part of the same electronic device or different electronic devices. In some implementations, the image-capture device 102 and the image-processing device 104 can be different devices. For instance, the image-capture device 102 can include a camera device and the image-processing device 104 can include a computing device, such as a mobile device, a desktop computer, a smartphone, a smart television, a game console, or other computing device.

While the image-processing system 100 is shown to include certain components, one of ordinary skill will appreciate that the image-processing system 100 can include more components than those shown in FIG. 1. The components of the image-processing system 100 can include software, hardware, or one or more combinations of software and hardware. For example, in some implementations, the components of the image-processing system 100 can include and/or can be implemented using electronic circuits or other electronic hardware, which can include one or more programmable electronic circuits (e.g., microprocessors, GPUs, DSPs, CPUs, and/or other suitable electronic circuits), and/or can include and/or be implemented using computer software, firmware, or any combination thereof, to perform the various operations described herein. The software and/or firmware can include one or more instructions stored on a computer-readable storage medium and executable by one or more processors of the electronic device implementing the image-processing system 100.

In some examples, the computing-device architecture 600 shown in FIG. 6 and further described below can include the image-processing system 100, the image-capture device 102, the image-processing device 104, or a combination thereof.

In some examples, the image-processing system 100 can create a composite image (e.g., an HDR image) using multiple images, with each image being captured with different image-capture parameters (e.g., different exposure times, pixel conversion gains, and/or sensor analog gain). For example, the image-processing system 100 can create an HDR image using a short exposure (SE) image and a long exposure (LE) image. In some cases, image-capture device 102 can capture the images (including full-readout images and/or partial-readout images) and write data representative of the images to a memory device, such as a DDR memory device or any other memory device (e.g., RAM 120). Image-processing device 104 can then retrieve the data representative of the images and combine (e.g., merge, fuse, etc.) the images into a single image. As previously explained, the different write, read, and combining operations used to create the HDR image can result in significant power and/or bandwidth consumption.

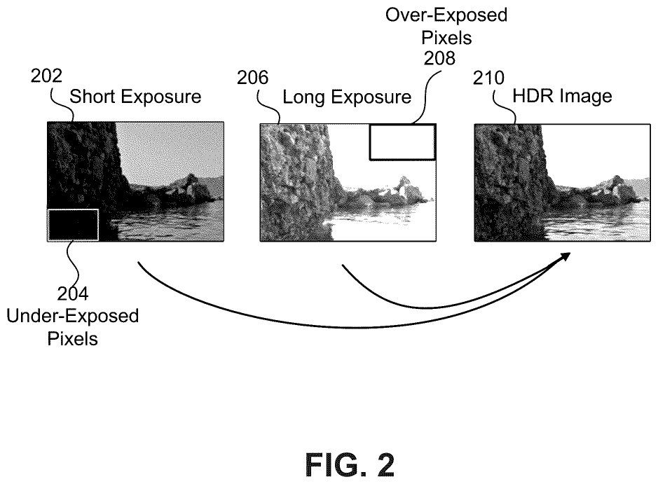

FIG. 2 illustrates multiple images, captured with different image-capture parameters, and used to create an HDR image 210. In particular, FIG. 2 shows a short-exposure image 202, a long-exposure image 206, and HDR image 210. HDR image 210 may be generated by combining portions of the short-exposure image 202 and portions of the long-exposure image 206. The short-exposure image 202 includes under-exposed pixels 204, and the long-exposure image 206 includes over-exposed pixels 208. As shown in FIG. 2, the under-exposed pixels 204 in the short-exposure image 202 and the over-exposed pixels 208 in the long-exposure image 206 do not contribute to the pixels of the HDR image 210.

Conventional HDR techniques may include an image-capture device (e.g., image-capture device 102) capturing two or more full-readout images (e.g., short-exposure image 202 and long-exposure image 206) and providing data representative of all of the pixels of all of the two or more full-readout images to an image-processing device (e.g., image-processing device 104), such as by writing the data to a memory (e.g., RAM 120). The operations to read, write, and process under-exposed pixels 204 in short-exposure image 202 and over-exposed pixels 208 in the long-exposure image 206 contribute to the overall power and bandwidth consumption of the image-processing system when creating the HDR image 210, even though such pixels do not contribute to the HDR image 210.

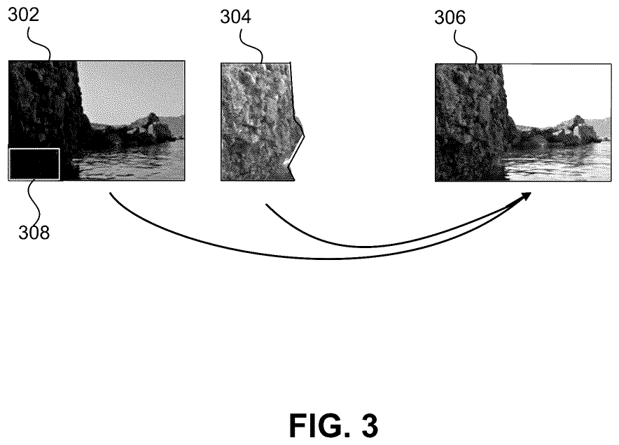

FIG. 3 illustrates multiple images used to generate a composite image 306 (e.g., an HDR image), according to various aspects of the present disclosure. More specifically, FIG. 3 illustrates an image 302 captured using first image-capture parameters, an image 304 captured using second image-capture parameters, and the composite image 306 which may be the result of combining pixels from image 302 and pixels from image 304, according to various aspects of the present disclosure.

An image-capture device (e.g., image-capture device 102 of FIG. 1) may capture the image 302 using all of the photodiodes of an array of photodiodes of the image-capture device (e.g., image 302 may be a full-readout image). Additionally, the image-capture device may capture the image 302 according to first image-capture parameters (e.g., a first exposure time, a first pixel conversion gain, and/or a first sensor analog gain). For example, the image-capture device may capture the image 302 using a relatively short exposure time, a relatively low pixel conversion gain, and/or a relatively low sensor analog gain, any or all of which may result in a relatively dark image including underexposed pixels 308.

The image-capture device may capture the image 304 using a subset of the photodiodes of the array of photodiodes of the image-capture device (e.g., image 304 may be a partial-readout image). Additionally, the image-capture device may capture the image 304 according to second image-capture parameters (e.g., a second exposure time, a second pixel conversion gain, and/or a second sensor analog gain). For example, the image-capture device may capture the image 304 using a relatively long exposure time (e.g., longer than the exposure time related to image 302), a relatively high pixel conversion gain (e.g., greater than the pixel conversion gain related to image 302), and/or a relatively high sensor analog gain (e.g., greater than the sensor analog gain related to image 302). As another example, the image-capture device may capture the image 304 using a relatively short exposure time (e.g., shorter than the exposure time related to image 302), a relatively low pixel conversion gain (e.g., less than the pixel conversion gain related to image 302), and/or a relatively low sensor analog gain (e.g., less than the sensor analog gain related to image 302).

According to the systems and techniques described herein, the image-capture device can determine or identify a region of interest. For example, the image-capture device may determine or identify the region of interest based on a location of the region of interest within the image of the field of view, a depth within a scene represented by the image of the field of view, a classification of the scene, an object detected in the image of the field of view, a semantic analysis of the image of the field of view, a gaze of a viewer, a user input, any combination thereof, and/or based on other information. Further, according to systems and techniques described herein, the image-capture device may determine a subset of the photodiodes of the array of photodiodes used to capture image 302 based on a correspondence between a location of the region of interest within the field of view and a location of the subset of the array of photodiodes within the array of photodiodes. The image-capture device can use the subset of the photodiodes to capture image 304. For example, if the region of interest includes a rectangular region in a quadrant of the field of view, the subset of photodiodes may include a rectangle-shaped group of photodiodes in a corresponding quadrant of the array of photodiodes.

Data representative of image 302 and data representative of image 304 may be provided (e.g., from the image-capture device which captured image 302 and image 304) to an image-processing device (e.g., image-processing device 104 of FIG. 1). The image-processing device may generate composite image 306 (e.g., an HDR image) based on image 302 and image 304. For instance, the image-capture device may generate composite image 306 by combining pixels of image 304 with pixels of image 302. In one example, the image-processing device may use all of the pixels of image 304 to replace corresponding pixels of image 302 to generate composite image 306.

The data representative of the of image 304 may be less than data representative of full-readout images that are used by conventional HDR techniques to generate HDR images. For example, the data representative of image 304 may be less than the data representative of long-exposure image 206 of FIG. 2. Because the data representative of image 304 is less than data representative of long-exposure image 206, the required data throughput of an image-processing system to generate composite image 306 based on image 302 and image 304 may be less than the required data throughput of an image processing system to generate HDR image 210 of FIG. 2 based on short-exposure image 202 of FIG. 2 and long-exposure image 206 of FIG. 2. Similarly, the data processing and memory requirements of an image-processing system to generate composite image 306 based on image 302 and image 304 may be less than that of an image processing system to generate HDR image 210 based on short-exposure image 202 and long exposure image 206. The data processing and/or memory requirements being lower than the data processing and/or memory requirements of other techniques allow the systems and techniques described herein to use a reduced amount of power compared with the other techniques.

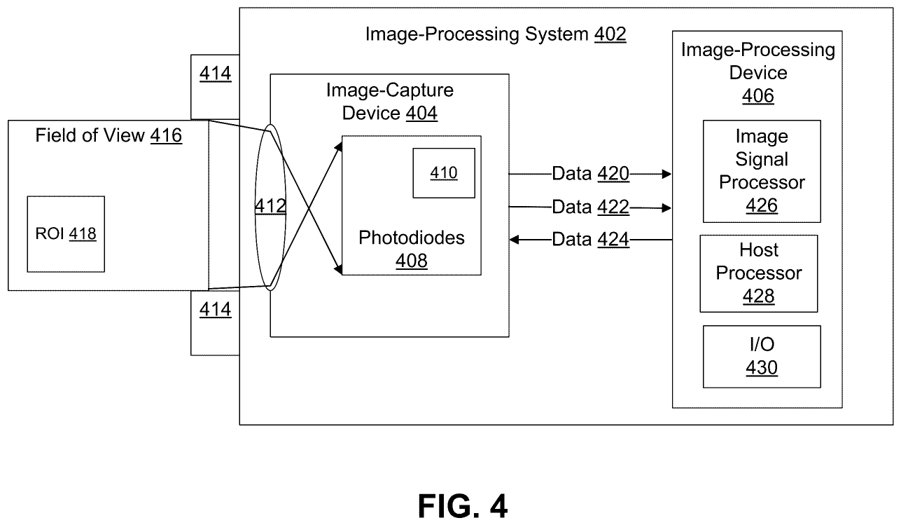

FIG. 4 is a block diagram illustrating an image-processing system 402 configured to generate a composite image (e.g., an HDR image) representing a field of view 416 of an image sensor of an image-capture device 404 of the image-processing system 402, according to various aspects of the present disclosure. According to systems and techniques described herein, image-capture device 404 may generate and provide data 420 (e.g., image data) representative of a full-readout image and data 422 (e.g., image data) representative of a partial-readout image to image-processing device 406. Image-processing device 406 may generate the composite image based on the full-readout image and the partial-readout image.

Image-processing system 402 may be the same as, substantially similar to, or perform the same, or substantially the same, operations as image-processing system 100 of FIG. 1. Image-capture device 404 may be the same as, substantially similar to, or perform the same, or substantially the same, operations as image-capture device 102 of FIG. 1. Image-processing device 406 may be the same as, substantially similar to, or perform the same, or substantially the same, operations as image-processing device 104 of FIG. 1.

Image-processing device 406 may include an image signal processor (ISP) 426, which may be the same as, substantially similar to, or perform the same, or substantially the same, operations ISP 128 of FIG. 1. Additionally, or alternatively, image-processing device 406 may include a host processor 428 (also referred to as an application processor (AP)), which may be the same as, substantially similar to, or perform the same, or substantially the same, operations host processor 126 of FIG. 1. Further, image-processing device 406 may include input/output (I/O) ports 430, which may be the same as, substantially similar to, or perform the same, or substantially the same, operations as ports 130 of FIG. 1. For example, the host processor 428 may communicate with the image-capture device 404 using two or more I2C ports of ports 430, and the ISP 426 may communicate with the image-capture device 404 using one or more MIPI ports of ports 430.

Aperture 414 and lens 412 may limit, direct, and/or focus light from field of view 416 onto photodiodes 408 of the image sensor (e.g., image sensor 118 of FIG. 1) of the image-capture device 404. Field of view 416 may be defined as a maximum area of a scene that the image sensor can capture (e.g., based on parameters of the image-capture device 404, such as focal length, aperture size, size of the image sensor in terms of number of photodiodes and sizes of the photodiodes, etc.) using photodiodes 408.

Photodiodes 408 may be an array of photodiodes. Each of photodiodes of the array may generate data (e.g., red, green, or blue data, based on filters at each of the photodiodes) indicative of light impinging on the photodiode. Data from photodiodes 408 collectively may be image data, representative of field of view 416.

Image-capture device 404 may receive light at photodiodes 408 and may generate data 420 representative of a full-readout image of field of view 416. The full-readout image may be captured according to first image-capture parameters (e.g., a first exposure time, a first pixel conversion gain, and/or a first sensor analog gain). Image-capture device 404 may provide data 420 to image-processing device 406 (e.g., by writing data 420 into a memory accessible by image-processing device 406). In providing data 420 to image-processing device 406, image-capture device 404 may transfer data 420 using one port of ports 430 (e.g., a MIPI port to provide data 420 to ISP 426).

Image-processing device 406 (or another system or component) may (e.g., using host processor 428) determine region of interest 418 of field of view 416. Region of interest 418 may be determined based on a location of the region of interest within the image of the field of view 416, a depth within a scene represented by the image of the field of view 416, a classification of the scene, an object detected in the image of the field of view 416, a semantic analysis of the image of the field of view, a gaze of a viewer, a user input (e.g., a user providing user input corresponding to selection of an object using a user interface of a device that includes the image-processing system 402), any combination thereof, and/or other information.

In some cases, image-processing device 406 may provide data 424 indicative of region of interest 418 to image-capture device 404. The image-capture device 404 may determine a subset of photodiodes 410 corresponding to region of interest 418. In other cases, image-processing device 406 may determine subset of photodiodes 410 and may provide data 424 indicative of subset of photodiodes 410 to image-capture device 404. In any case, a relationship between subset of photodiodes 410 and photodiodes 408 may correspond to a relationship between region of interest 418 and field of view 416. For example, if the region of interest includes a rectangular region in a lower-left quadrant of the field of view, the subset of photodiodes may include a rectangle-shaped group of photodiodes in an upper-right quadrant (e.g., because light from field of view 416 may be focused and reversed by passing through lens 412 before arriving at the photodiodes 408) of photodiodes 408.

Image-capture device 404 may receive light at subset of photodiodes 410 and may generate data 422 representative of a partial-readout image of region of interest 418. The partial-readout image may have been captured according to second image-capture parameters, that may be different from the first image-capture parameters. Image-capture device 404 may provide data 422 to image-processing device 406. In providing data 422 to image-processing device 406, image-capture device 404 may transfer data 422 using one port of ports 430 (e.g., an I2C port to provide data 420 to host processor 428 or a MIPI port to provide data 420 to ISP 426). In some cases, image-capture device 404 may use the same port to provide data 420 and data 422. In other cases, image-capture device 404 may use separate ports of ports 430 to provide data 420 and to provide data 422.

Image-processing device 406 may generate a composite image (e.g., an HDR image) including pixels from the partial-readout image captured by subset of photodiodes 410 (represented by data 422) and pixels from the full-readout image captured by photodiodes 408 (represented by data 420).

In some cases, image-processing device 406 may perform HDR techniques using host processor 428 and/or ISP 426. In some cases, image-processing device 406 may process data 420 using one imaging stream and may process data 422 using another imaging stream. In such cases, image-capture device 404 may provide data 420 and data 422 on separate ports of ports 430 or on a common port of ports 430 (e.g., different streams can use different MIPI “virtual channels” or different MIPI data types to achieve time-multiplexing using one MIPI port). In some cases, ISP 426 can process one or more regions of field of view 416 that are outside of the ROI 418 using one imaging stream and can process ROI 418 using another imaging stream. Image-processing device 406, using host processor 428, can generate the composite image using both imaging streams. Further, in some cases, the full FOB imaging stream can have a lower resolution and/or image-processing device 406 may apply a compression scheme (e.g., piece-wise linear (PWL) companding or image compression) to further reduce power and bandwidth of the full FOV imaging stream. Further still, image-processing device 406 may use a lower bit-width, either using analog method (ADC) or in the digital domain.

In some cases, photodiodes 408 may be a subset of a larger array of photodiodes. For example, photodiodes 408 may represent a selection of photodiodes from the larger array according to a cropped, or digitally zoomed, view of field of view 416. In such cases, subset of photodiodes 410 may still be a subset of photodiodes 408 and subset of photodiodes 410 may still include fewer photodiodes than photodiodes 408.

Data 422, representative of region of interest 418, may be smaller than data representative of other second images of conventional HDR techniques. For example, data 422 may be smaller than the data representative of long-exposure image 206 of FIG. 2. Because data 422 is smaller than data representative of long-exposure image 206, the required data throughput between image-capture device 404 and image-processing device 406 may be less than the required data throughput of an image processing system to generate HDR image 210 of FIG. 2 based on short-exposure image 202 of FIG. 2 and long-exposure image 206 of FIG. 2. Similarly, the data processing and memory requirements of image-processing system 402 may be less than that of an image processing system to generate HDR image 210 based on short-exposure image 202 and long exposure image 206. As noted previously, the data processing and/or memory requirements being lower than the data processing and/or memory requirements of other techniques allow the systems and techniques described herein to use less power as compared with the other techniques.

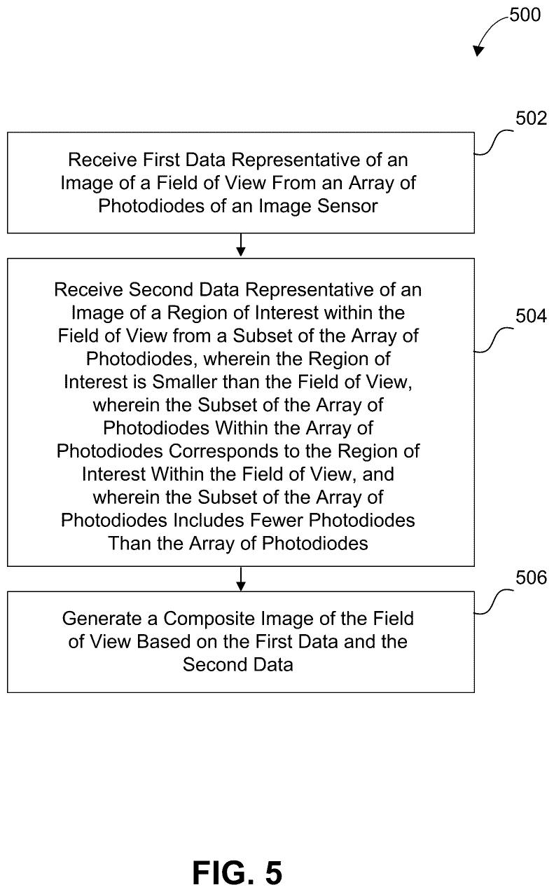

FIG. 5 illustrates an example of a process 500 for generating a composite image, according to aspects of the according to various aspects of the present disclosure. The process 500 may be performed by a computing device (or apparatus) or a component (e.g., a chipset, one or more processors, etc.) of the computing device. The computing device may be an extended reality (XR) device (e.g., a virtual reality (VR) device or augmented reality (AR) device), a mobile device (e.g., a mobile phone), a camera (e.g., an internet protocol (IP) camera, a surveillance camera, etc.) a network-connected wearable such as a watch, and/or other type of computing device. The operations of the process 500 may be implemented as software components that are executed and run on one or more compute components or processors (e.g., image-processing device 104 of FIG. 1, image processor 124 of FIG. 1, host processor 126 of FIG. 1, ISP 128 of FIG. 1, image-processing device 406 of FIG. 4, processor 604 of FIG. 6, or other processor(s)). Transmission and reception of signals by the computing device in the process 500 may be enabled, for example, by one or more antennas, one or more transceivers (e.g., wireless transceiver(s)), and/or other communication components (e.g., the communication interface 624 of FIG. 6, or other antennae(s), transceiver(s), and/or component(s)). Providing and/or receiving of data may be through transmissions and/or through wired connections (e.g., between image sensor 118 and image processor 124 or between image-capture device 404 and image-processing device 406).

At block 502, a computing device (or component thereof) may receive first data representative of an image of a field of view from an array of photodiodes of an image sensor. For example, image-processing device 406 may receive data 420, which may be representative of an image of field of view 416 from photodiodes 408 of image-capture device 404.

In some aspects, the computing device (or one or more components thereof) may determine the region of interest within the field of view. For example, image-processing device 406 may determine region of interest 418 within field of view 416. In some aspects, the computing device (or one or more components thereof) may determine the region of interest based on an object detected in the image of the field of view. For example, image-processing device 406 may determine region of interest 418 based on an object detected within field of view 416. In some aspects, the computing device (or one or more components thereof) may determine the region of interest based on a gaze of a viewer. For example, image-processing device 406 may determine region of interest 418 based on a gaze of a viewer.

In some aspects, receiving the first data from the array of photodiodes of the image sensor (e.g., at block 502) may include receiving the first data from all of the photodiodes of the array of photodiodes. For example, image-processing device 406 may receive data 420, which may include data from all of the photodiodes of array of photodiodes 408. In other aspects, receiving the first data from the array of photodiodes of the image sensor (e.g., at block 502) may include receiving the first data from fewer than all of the photodiodes of the array of photodiodes. For example, image-processing device 406 may receive data 420, which may include data from fewer than all of the photodiodes of array of photodiodes 408.

At block 504, the computing device (or one or more components thereof) may receive second data representative of an image of a region of interest within the field of view from a subset of the array of photodiodes. The region of interest may be smaller than the field of view. The subset of the array of photodiodes within the array of photodiodes may correspond to the region of interest within the field of view. The subset of the array of photodiodes may include fewer photodiodes than the array of photodiodes. For example, image-processing device 406 may receive data 422, which may be representative of an image of region of interest 418 within field of view 416 from subset of photodiodes 410. Region of interest 418 may be smaller than field of view 416. Subset of photodiodes 410 may correspond to region of interest 418 within field of view 416. Subset of photodiodes 418 may include fewer photodiodes than the array of photodiodes 408.

In some aspects, receiving the second data from the subset of the array of photodiodes (e.g., at block 504) may include receiving the second data only from the subset of the array of photodiodes. For example, image-processing device 406 may receive data 422, which may include data only from subset of photodiodes 410. In some aspects, receiving the second data from the subset of the array of photodiodes (e.g, at block 504) may include not receiving data from any of the photodiodes of the array of photodiodes outside the subset of the array of photodiodes. For example, image-processing device 406 may receive data 422, which may not include data from photodiodes outside subset of photodiodes 410.

In some aspects, the computing device (or one or more components thereof) may determine the subset of the array of photodiodes based on a correspondence between a relationship between the subset of the array of photodiodes and the array of photodiodes and a relationship between the region of interest and the field of view. For example, image-processing device 406 may determine subset of photodiodes 410 based on a correspondence between the location of region of interest 418 within field of view 416 and the location of subset of photodiodes 410 within array of photodiodes 408.

In some aspects, a first portion of the composite image corresponding to the region of interest may be associated with a first dynamic range and a second portion of the composite image outside of the region of interest is associated with a second dynamic range. For example, a first portion of the composite image generated by image-processing device 406 may correspond to region of interest 418 (and to subset of photodiodes 410). A second portion of the composite image may correspond to the remainder of field of view 416 (and to the remainder of array of photodiodes 408). The first portion of the composite image may be associated with a first dynamic range (e.g., based on the first portion being captured according to first image-capture parameters). The second portion of the composite image may be associated with a second dynamic range (e.g., based o the second portion of the image being captured according to second image-capture parameters).

In some aspects, the first data (e.g., received at block 502) may be associated with first one or more image-capture parameters, and the second data (e.g., received at block 504) may be associated with second one or more image-capture parameters. In some aspects, the first one or more image-capture parameters may include at least one of a first exposure time, a first pixel conversion gain, or a first sensor analog gain. The second one or more image-capture parameters may include at least one of a second exposure time, a second pixel conversion gain, or a second sensor analog gain. For example, data 420 may be captured according to first image-capture parameters (e.g., a first exposure time, a first pixel conversion gain, and/or a first sensor analog gain). Data 422 may be captured according to second image-capture parameters (e.g., a second exposure time, a second pixel conversion gain, and/or a second sensor analog gain).

At block 506, the computing device (or one or more components thereof) may generate a composite image of the field of view based on the first data and the second data. For example, image-processing device 406 may generate a composite image of field of view 416 based on data 420 and data 422.

In some aspects, generating the composite image (e.g., at block 506) may include overwriting a portion of the first data representative of the region of interest with the second data. For example, image-processing device 406, in generating the composite image, may overwrite a portion of data 420 representative of region of interest 418 with data 422. In some aspects, the computing device (or one or more components thereof) may blend a second portion of the first data representative of a periphery of the region of interest with the second data. For example, image-processing device 406, in generating the composite image, may blend a portion of data 420 representative of a periphery of region of interest 418 with data 422.

In some examples, the methods described herein (e.g., process 500 and/or other methods described herein) can be performed by a computing device or apparatus. In one example, one or more of the methods can be performed by image-processing system 100 of FIG. 1, image-processing device 104 of FIG. 1, image processor 124 of FIG. 1, host processor 126 of FIG. 1, ISP 128 of FIG. 1, image-processing system 402 of FIG. 4, image-processing device 406 of FIG. 4, ISP 426 of FIG. 4, or host processor 428 of FIG. 4. In another example, one or more of the methods can be performed by the computing-device architecture 600 shown in FIG. 6. For instance, a computing device with the computing-device architecture 600 shown in FIG. 6 can include the components of the image-processing system 100 of FIG. 1, image-processing device 104 of FIG. 1, image processor 124 of FIG. 1, host processor 126 of FIG. 1, ISP 128 of FIG. 1, image-processing system 402 of FIG. 4, image-processing device 406 of FIG. 4, ISP 426 of FIG. 4, or host processor 428 of FIG. 4 and can implement the operations of the process 500 of FIG. 5, and/or other process described herein.

The computing device can include any suitable device, such as a vehicle or a computing device of a vehicle, a mobile device (e.g., a mobile phone), a desktop computing device, a tablet computing device, a wearable device (e.g., a VR headset, an AR headset, AR glasses, a network-connected watch or smartwatch, or other wearable device), a server computer, a robotic device, a television, and/or any other computing device with the resource capabilities to perform the processes described herein, including process 500, and/or other process described herein. In some cases, the computing device or apparatus can include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device can include a display, a network interface configured to communicate and/or receive the data, any combination thereof, and/or other component(s). The network interface can be configured to communicate and/or receive Internet Protocol (IP) based data or other type of data.

The components of the computing device can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein. [0093] process 500 and/or other process described herein are illustrated as logical flow diagrams, the operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, process 500, and/or other process described herein can be performed under the control of one or more computer systems configured with executable instructions and can be implemented as code (e.g., executable instructions, one or more computer programs, or one or more applications) executing collectively on one or more processors, by hardware, or combinations thereof. As noted above, the code can be stored on a computer-readable or machine-readable storage medium, for example, in the form of a computer program comprising a plurality of instructions executable by one or more processors. The computer-readable or machine-readable storage medium can be non-transitory.

FIG. 6 illustrates an example computing-device architecture 600 of an example computing device which can implement the various techniques described herein. In some examples, the computing device can include a mobile device, a wearable device, an extended reality device (e.g., a virtual reality (VR) device, an augmented reality (AR) device, or a mixed reality (MR) device), a personal computer, a laptop computer, a video server, a vehicle (or computing device of a vehicle), or other device. For example, the computing-device architecture 600 may include image-processing system 100 of FIG. 1. The components of computing-device architecture 600 are shown in electrical communication with each other using connection 602, such as a bus. The example computing-device architecture 600 includes a processing unit (CPU or processor) 604 and computing device connection 602 that couples various computing device components including computing device memory 608, such as read only memory (ROM) 610 and random-access memory (RAM) 612, to processor 604.

Computing-device architecture 600 can include a cache of high-speed memory connected directly with, in close proximity to, or integrated as part of processor 604. Computing-device architecture 600 can copy data from memory 608 and/or the storage device 614 to cache 606 for quick access by processor 604. In this way, the cache can provide a performance boost that avoids processor 604 delays while waiting for data. These and other modules can control or be configured to control processor 604 to perform various actions. Other computing device memory 608 may be available for use as well. Memory 608 can include multiple different types of memory with different performance characteristics. Processor 604 can include any general-purpose processor and a hardware or software service, such as service 1 616, service 2 618, and service 3 620 stored in storage device 614, configured to control processor 604 as well as a special-purpose processor where software instructions are incorporated into the processor design. Processor 604 may be a self-contained system, containing multiple cores or processors, a bus, memory controller, cache, etc. A multi-core processor may be symmetric or asymmetric.

To enable user interaction with the computing-device architecture 600, input device 626 can represent any number of input mechanisms, such as a microphone for speech, a touch-sensitive screen for gesture or graphical input, keyboard, mouse, motion input, speech and so forth. Output device 622 can also be one or more of a number of output mechanisms known to those of skill in the art, such as a display, projector, television, speaker device, etc. In some instances, multimodal computing devices can enable a user to provide multiple types of input to communicate with computing-device architecture 600. Communication interface 624 can generally govern and manage the user input and computing device output. There is no restriction on operating on any particular hardware arrangement and therefore the basic features here may easily be substituted for improved hardware or firmware arrangements as they are developed.

Storage device 614 is a non-volatile memory and can be a hard disk or other types of computer readable media which can store data that are accessible by a computer, such as magnetic cassettes, flash memory cards, solid state memory devices, digital versatile disks, cartridges, random-access memories (RAMs) 612, read only memory (ROM) 610, and hybrids thereof. Storage device 614 can include services 616, 618, and 620 for controlling processor 604. Other hardware or software modules are contemplated. Storage device 614 can be connected to the computing device connection 602. In one aspect, a hardware module that performs a particular function can include the software component stored in a computer-readable medium in connection with the necessary hardware components, such as processor 604, connection 602, output device 622, and so forth, to carry out the function.

Aspects of the present disclosure are applicable to any suitable electronic device (such as security systems, smartphones, tablets, laptop computers, vehicles, drones, or other devices) including or coupled to one or more active depth sensing systems. While described below with respect to a device having or coupled to one light projector, aspects of the present disclosure are applicable to devices having any number of light projectors and are therefore not limited to specific devices.

The term “device” is not limited to one or a specific number of physical objects (such as one smartphone, one controller, one processing system and so on). As used herein, a device may be any electronic device with one or more parts that may implement at least some portions of this disclosure. While the below description and examples use the term “device” to describe various aspects of this disclosure, the term “device” is not limited to a specific configuration, type, or number of objects. Additionally, the term “system” is not limited to multiple components or specific aspects. For example, a system may be implemented on one or more printed circuit boards or other substrates and may have movable or static components. While the below description and examples use the term “system” to describe various aspects of this disclosure, the term “system” is not limited to a specific configuration, type, or number of objects.

Specific details are provided in the description above to provide a thorough understanding of the aspects and examples provided herein. However, it will be understood by one of ordinary skill in the art that the aspects may be practiced without these specific details. For clarity of explanation, in some instances the present technology may be presented as including individual functional blocks including functional blocks including devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general-purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as flash memory, memory or memory devices, magnetic or optical disks, flash memory, USB devices provided with non-volatile memory, networked storage devices, compact disk (CD) or digital versatile disk (DVD), any suitable combination thereof, among others. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some aspects the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

The various illustrative logical blocks, modules, circuits, and algorithm steps described in connection with the aspects disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general-purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium including program code including instructions that, when executed, performs one or more of the methods described above. The computer-readable data storage medium may form part of a computer program product, which may include packaging materials. The computer-readable medium may include memory or data storage media, such as random-access memory (RAM) such as synchronous dynamic random-access memory (SDRAM), read-only memory (ROM), non-volatile random-access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general-purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or any other such configuration). Accordingly, the term “processor,” as used herein may refer to any of the foregoing structure, any combination of the foregoing structure, or any other structure or apparatus suitable for implementation of the techniques described herein.

Illustrative aspects of the disclosure include:

Aspect 1. An apparatus for generating a composite image, the apparatus comprising: at least one memory; and at least one processor coupled to the at least one memory and configured to: receive first data representative of an image of a field of view from an array of photodiodes of an image sensor; receive second data representative of an image of a region of interest within the field of view from a subset of the array of photodiodes, wherein the region of interest is smaller than the field of view, wherein the subset of the array of photodiodes within the array of photodiodes corresponds to the region of interest within the field of view, and wherein the subset of the array of photodiodes includes fewer photodiodes than the array of photodiodes; and generate a composite image of the field of view based on the first data and the second data.

Aspect 2. The apparatus of aspect 1, wherein the at least one processor is further configured to determine the region of interest within the field of view.

Aspect 3. The apparatus of any one of aspects 1 or 2, wherein the at least one processor is further configured to determine the subset of the array of photodiodes based on a correspondence between a relationship between the subset of the array of photodiodes and the array of photodiodes and a relationship between the region of interest and the field of view.

Aspect 4. The apparatus of any one of aspects 1 to 3, wherein a first portion of the composite image corresponding to the region of interest is associated with a first dynamic range and a second portion of the composite image outside of the region of interest is associated with a second dynamic range.

Aspect 5. The apparatus of any one of aspects 1 to 4, wherein the first data is associated with first one or more image-capture parameters, and wherein the second data is associated with second one or more image-capture parameters.

Aspect 6. The apparatus of aspect 5, wherein the first one or more image-capture parameters comprise at least one of a first exposure time, a first pixel conversion gain, or a first sensor analog gain, and wherein the second one or more image-capture parameters comprise at least one of a second exposure time, a second pixel conversion gain, or a second sensor analog gain.

Aspect 7. The apparatus of any one of aspects 1 to 6, wherein the at least one processor is further configured to determine the region of interest based on an object detected in the image of the field of view.

Aspect 8. The apparatus of any one of aspects 1 to 7, wherein the at least one processor is further configured to determine the region of interest based a gaze of a viewer.

Aspect 9. The method of any one of aspects 1 to 8, wherein to receive the first data from the array of photodiodes of the image sensor the at least one processor is configured to receive the first data from all of the photodiodes of the array of photodiodes.

Aspect 10. The method of any one of aspects 1 to 8, wherein to receive the first data from the array of photodiodes of the image sensor the at least one processor is configured to receive the first data from fewer than all of the photodiodes of the array of photodiodes.

Aspect 11. The method of any one of aspects 1 to 10, wherein to receive the second data from the subset of the array of photodiodes the at least one processor is configured to receive the second data only from the subset of the array of photodiodes.

Aspect 12. The method of any one of aspects 1 to 11, wherein to receive the second data from the subset of the array of photodiodes the at least one processor is configured to not receive data from any of the photodiodes of the array of photodiodes outside the subset of the array of photodiodes.

Aspect 13. The method of any one of aspects 1 to 12, wherein to generate the composite image the at least one processor is configured to overwrite a portion of the first data representative of the region of interest with the second data.

Aspect 14. The method of aspect 13, wherein the at least one processor is further configured to blend a second portion of the first data representative of a periphery of the region of interest with the second data.

Aspect 15. A method for generating a composite image, comprising: receiving first data representative of an image of a field of view from an array of photodiodes of an image sensor; receiving second data representative of an image of a region of interest within the field of view from a subset of the array of photodiodes, wherein the region of interest is smaller than the field of view, wherein the subset of the array of photodiodes within the array of photodiodes corresponds to the region of interest within the field of view, and wherein the subset of the array of photodiodes includes fewer photodiodes than the array of photodiodes; and generating a composite image of the field of view based on the first data and the second data.

Aspect 16. The method of aspect 15, further comprising determining the region of interest within the field of view.

Aspect 17. The method of any one of aspects 15 or 16, further comprising determining the subset of the array of photodiodes based on a correspondence between a relationship between the subset of the array of photodiodes and the array of photodiodes and a relationship between the region of interest and the field of view.

Aspect 18. The method of any one of aspects 15 to 17, wherein a first portion of the composite image corresponding to the region of interest is associated with a first dynamic range and a second portion of the composite image outside of the region of interest is associated with a second dynamic range.

Aspect 19. The method of any one of aspects 15 to 18, wherein the first data is associated with first one or more image-capture parameters, and wherein the second data is associated with second one or more image-capture parameters.

Aspect 20. The method of aspect 19, wherein the first one or more image-capture parameters comprise at least one of a first exposure time, a first pixel conversion gain, or a first sensor analog gain, and wherein the second one or more image-capture parameters comprise at least one of a second exposure time, a second pixel conversion gain, or a second sensor analog gain.

Aspect 21. The method of any one of aspects 15 to 20, further comprising determining the region of interest based on an object detected in the image of the field of view.

Aspect 22. The method of any one of aspects 15 to 21, further comprising determining the region of interest based a gaze of a viewer.

Aspect 23. The method of any one of aspects 15 to 22, wherein receiving the first data from the array of photodiodes of the image sensor comprises receiving the first data from all of the photodiodes of the array of photodiodes.

Aspect 24. The method of any one of aspects 15 to 22, wherein receiving the first data from the array of photodiodes of the image sensor comprises receiving the first data from fewer than all of the photodiodes of the array of photodiodes.

Aspect 25. The method of any one of aspects 15 to 24, wherein receiving the second data from the subset of the array of photodiodes comprises receiving the second data only from the subset of the array of photodiodes.

Aspect 26. The method of any one of aspects 15 to 25, wherein receiving the second data from the subset of the array of photodiodes comprises not receiving data from any of the photodiodes of the array of photodiodes outside the subset of the array of photodiodes.

Aspect 27. The method of any one of aspects 15 to 26, wherein generating the composite image comprises overwriting a portion of the first data representative of the region of interest with the second data.

Aspect 28. The method of any one of aspects 15 to 27, further comprising blending a second portion of the first data representative of a periphery of the region of interest with the second data.

Aspect 29. The method of any one of aspects 15 to 28, further comprising determining the region of interest based on at least one of: a pre-determined location of the region of interest within the image of the field of view; a depth within a scene represented by the image of the field of view; a classification of the scene; an object detected in the image of the field of view; an object tracked in the image of the field of view; a semantic analysis of the image of the field of view; a saliency analysis of the image of the field of view; a gaze of a viewer; or a user input.

Aspect 30. The method of any one of aspects 15 to 29, wherein the image of the field of view comprises a first image of the field of view; wherein the method further comprises receiving third data representative of a second image of the field of view from the array of photodiodes of an image sensor; wherein the method further comprises determining the region of interest based on at least one of: a pre-determined location of the region of interest within the second image of the field of view; a depth within a scene represented by the second image of the field of view; a classification of the scene; an object detected in the second image of the field of view; an object tracked in the second image of the field of view; a semantic analysis of the second image of the field of view; or a saliency analysis of the image of the field of view.

Aspect 31. A non-transitory computer-readable storage medium having stored thereon instructions that, when executed by at least one processor, cause the at least one processor to perform operations according to any of aspects 15 to 30.

Aspect 32. An apparatus for providing virtual content for display, the apparatus comprising one or more means for perform operations according to any of aspects 15 to 30.

Aspect 33. The apparatus of any one of aspects 1 to 14, wherein the at least one processor is further configured to determine the region of interest based on at least one of: a pre-determined location of the region of interest within the image of the field of view; a depth within a scene represented by the image of the field of view; a classification of the scene; an object detected in the image of the field of view; an object tracked in the image of the field of view; a semantic analysis of the image of the field of view; a saliency analysis of the image of the field of view; a gaze of a viewer; or a user input.

Aspect 34. The apparatus of any one of aspects 1 to 14, wherein the image of the field of view comprises a first image of the field of view; wherein the at least one processor is further configured to receive third data representative of a second image of the field of view from the array of photodiodes of an image sensor; wherein the at least one processor is further configured to determine the region of interest based on at least one of: a pre-determined location of the region of interest within the second image of the field of view; a depth within a scene represented by the second image of the field of view; a classification of the scene; an object detected in the second image of the field of view; an object tracked in the second image of the field of view; a semantic analysis of the second image of the field of view; or a saliency analysis of the image of the field of view.

What is claimed is:

1. An apparatus for generating a composite image, the apparatus comprising:
at least one memory; and
at least one processor coupled to the at least one memory and configured to:
receive first data representative of an image of a field of view from an array of photodiodes of an image sensor;
receive second data representative of an image of a region of interest within the field of view from a subset of the array of photodiodes, wherein the region of interest is smaller than the field of view, wherein the subset of the array of photodiodes within the array of photodiodes corresponds to the region of interest within the field of view, and wherein the subset of the array of photodiodes includes fewer photodiodes than the array of photodiodes; and
generate a composite image of the field of view based on the first data and the second data.

2. The apparatus of claim 1, wherein the at least one processor is further configured to determine the region of interest within the field of view.

3. The apparatus of claim 1, wherein the at least one processor is further configured to determine the subset of the array of photodiodes based on a correspondence between a relationship between the subset of the array of photodiodes and the array of photodiodes and a relationship between the region of interest and the field of view.

4. The apparatus of claim 1, wherein a first portion of the composite image corresponding to the region of interest is associated with a first dynamic range and a second portion of the composite image outside of the region of interest is associated with a second dynamic range.

5. The apparatus of claim 1, wherein the first data is associated with first one or more image-capture parameters, and wherein the second data is associated with second one or more image-capture parameters.

6. The apparatus of claim 5, wherein the first one or more image-capture parameters comprise at least one of a first exposure time, a first pixel conversion gain, or a first sensor analog gain, and wherein the second one or more image-capture parameters comprise at least one of a second exposure time, a second pixel conversion gain, or a second sensor analog gain.

7. The apparatus of claim 1, wherein the at least one processor is further configured to determine the region of interest based on an object detected in the image of the field of view.

8. The apparatus of claim 1, wherein the at least one processor is further configured to determine the region of interest based a gaze of a viewer.

9. The method of claim 1, wherein to receive the first data from the array of photodiodes of the image sensor the at least one processor is configured to receive the first data from all of the photodiodes of the array of photodiodes.

10. The method of claim 1, wherein to receive the first data from the array of photodiodes of the image sensor the at least one processor is configured to receive the first data from fewer than all of the photodiodes of the array of photodiodes.

11. The method of claim 1, wherein to receive the second data from the subset of the array of photodiodes the at least one processor is configured to receive the second data only from the subset of the array of photodiodes.

12. The method of claim 1, wherein to receive the second data from the subset of the array of photodiodes the at least one processor is configured to not receive data from any of the photodiodes of the array of photodiodes outside the subset of the array of photodiodes.

13. The method of claim 1, wherein to generate the composite image the at least one processor is configured to overwrite a portion of the first data representative of the region of interest with the second data.

14. The method of claim 13, wherein the at least one processor is further configured to blend a second portion of the first data representative of a periphery of the region of interest with the second data.

15. A method for generating a composite image, comprising:
receiving first data representative of an image of a field of view from an array of photodiodes of an image sensor;
receiving second data representative of an image of a region of interest within the field of view from a subset of the array of photodiodes, wherein the region of interest is smaller than the field of view, wherein the subset of the array of photodiodes within the array of photodiodes corresponds to the region of interest within the field of view, and wherein the subset of the array of photodiodes includes fewer photodiodes than the array of photodiodes; and
generating a composite image of the field of view based on the first data and the second data.

16. The method of claim 15, further comprising determining the region of interest within the field of view.

17. The method of claim 15, further comprising determining the subset of the array of photodiodes based on a correspondence between a relationship between the subset of the array of photodiodes and the array of photodiodes and a relationship between the region of interest and the field of view.

18. The method of claim 15, wherein a first portion of the composite image corresponding to the region of interest is associated with a first dynamic range and a second portion of the composite image outside of the region of interest is associated with a second dynamic range.

19. The method of claim 15, wherein the first data is associated with first one or more image-capture parameters, and wherein the second data is associated with second one or more image-capture parameters.

20. The method of claim 19, wherein the first one or more image-capture parameters comprise at least one of a first exposure time, a first pixel conversion gain, or a first sensor analog gain, and wherein the second one or more image-capture parameters comprise at least one of a second exposure time, a second pixel conversion gain, or a second sensor analog gain.

21. The method of claim 15, further comprising determining the region of interest based on an object detected in the image of the field of view.

22. The method of claim 15, further comprising determining the region of interest based a gaze of a viewer.

23. The method of claim 15, wherein receiving the first data from the array of photodiodes of the image sensor comprises receiving the first data from all of the photodiodes of the array of photodiodes.

24. The method of claim 15, wherein receiving the first data from the array of photodiodes of the image sensor comprises receiving the first data from fewer than all of the photodiodes of the array of photodiodes.

25. The method of claim 15, wherein receiving the second data from the subset of the array of photodiodes comprises receiving the second data only from the subset of the array of photodiodes.

26. The method of claim 15, wherein receiving the second data from the subset of the array of photodiodes comprises not receiving data from any of the photodiodes of the array of photodiodes outside the subset of the array of photodiodes.

27. The method of claim 15, wherein generating the composite image comprises overwriting a portion of the first data representative of the region of interest with the second data.

28. The method of claim 27, further comprising blending a second portion of the first data representative of a periphery of the region of interest with the second data.

29. A non-transitory computer-readable storage medium having stored thereon instructions that, when executed by at least one processor, cause the at least one processor to:
receive first data representative of an image of a field of view from an array of photodiodes of an image sensor;
receive second data representative of an image of a region of interest within the field of view from a subset of the array of photodiodes, wherein the region of interest is smaller than the field of view, wherein the subset of the array of photodiodes within the array of photodiodes correspond to the region of interest within the field of view, and wherein the subset of the array of photodiodes include fewer photodiodes than the array of photodiodes; and
generate a composite image of the field of view based on the first data and the second data.

30. An apparatus for generating a composite image, comprising:
means for receiving first data representative of an image of a field of view from an array of photodiodes of an image sensor;
means for receiving second data representative of an image of a region of interest within the field of view from a subset of the array of photodiodes, wherein the region of interest is smaller than the field of view, wherein the subset of the array of photodiodes within the array of photodiodes correspond to the region of interest within the field of view, and wherein the subset of the array of photodiodes include fewer photodiodes than the array of photodiodes; and
means for generating a composite image of the field of view based on the first data and the second data.
